(19) United States
(12) Patent Application Publication
(10) Pub. No.: US 2021/0242455 A1
(43) Pub. Date: Aug. 5, 2021

(54) NEGATIVE ACTIVE MATERIAL FOR RECHARGEABLE LITHIUM BATTERY, AND RECHARGEABLE LITHIUM BATTERY INCLUDING SAME

(71) Applicant: Samsung SDI Co., Ltd., Yongin-si (KR)

(72) Inventor: Chul YOUM, Yongin-si (KR)

(21) Appl. No.: 17/156,457

(22) Filed: Jan. 22, 2021

(30) Foreign Application Priority Data
Feb. 5, 2020 (KR) 10-2020-0013799

(51) Int. Cl. H01M 4/36; H01M 10/0525; H01M 4/38; H01M 4/587; H01M 4/48

(52) U.S. Cl. CPC H01M 4/366; H01M 10/0525; H01M 4/364; H01M 2004/021; H01M 4/587; H01M 4/483; H01M 4/386

(57) ABSTRACT

Disclosed is a negative active material for a rechargeable lithium battery and a rechargeable lithium battery including the same. The negative active material includes: a silicon primary particle core having a particle size of micrometers; a particle layer formed by agglomerating silicon oxide primary particles having a particle size of 10 nm or less on a surface of the core, the particle layer including pores; and a carbon-based material filled in the pores of the particle layer.

### CROSS-REFERENCE TO RELATED APPLICATION

This application claims priority to and the benefit of Korean Patent Application No. 10-2020-0013799 filed in the Korean Intellectual Property Office on Feb. 5, 2020, the entire contents of which are hereby incorporated by reference.

### BACKGROUND

### 1. Field

Embodiments of this disclosure relate to a negative active material for a rechargeable lithium battery and a rechargeable lithium battery.

### 2. Description of the Related Art

A rechargeable lithium battery has recently drawn attention as a power source for small portable electronic devices. The rechargeable lithium battery uses an organic electrolyte solution and thereby has twice or more of a discharge voltage than an existing battery using an alkali aqueous solution and accordingly, has high energy density.

As for a positive active material of a rechargeable lithium battery, a lithium-transition metal oxide having a structure capable of intercalating lithium ions, such as LiCoO₂, LiMn₂O₄, LiNi₁₋ₓCoₓO₂ (0<x<1), and the like has been used.

As a negative active material, various carbon-based negative active materials such as artificial graphite, natural graphite, hard carbon, and/or the like have been mainly used.

The above information disclosed in this Background section is only for enhancement of understanding of the background of the present disclosure, and therefore it may contain information that does not form the prior art that is already known in this country to a person of ordinary skill in the art.

### SUMMARY

One embodiment provides a negative active material for a rechargeable lithium battery exhibiting excellent capacity and cycle-life characteristics.

Another embodiment provides a rechargeable lithium battery including the negative active material.

One embodiment provides a negative active material for a rechargeable lithium battery including: a silicon primary particle core having a particle size of micrometers; a particle layer formed by agglomerating silicon oxide primary particles having a particle size of about 10 nm or less on a surface of the core, the particle layer including pores; and amorphous carbon filled in the pores.

The silicon primary particle core may have a particle size in a range of about 1 μm to about 20 μm.

The silicon oxide primary particle may have a particle size in a range of about 1 nm to about 10 nm.

The particle layer may have a thickness in a range of about 60 nm to about 500 nm.

The particle layer may be continuously positioned on the surface of the core in a form of a layer.

An amount of the carbon-based material may be in a range of about 1 wt % to about 5 wt % based on the total of 100 wt % of the negative active material.

The carbon-based material may include amorphous carbon.

Another embodiment provides a rechargeable lithium battery including: the negative electrode including the negative active material; a positive electrode; and an electrolyte.

Other embodiments are included in the following detailed description.

A negative active material for a rechargeable lithium battery according to one embodiment may provide a rechargeable lithium battery exhibiting excellent capacity and good cycle-life characteristics.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a schematic view showing a structure of the negative active material according to an embodiment.

FIG. 2 is a drawing further showing the structure of a portion of the particle layer in negative active material shown in FIG. 1.

FIG. 3 is a schematic view showing a structure of a rechargeable lithium battery according to one embodiment.

FIG. 4 is a 150,000 times TEM image of the negative active material according to Example 1.

FIG. 5 is a 50,000 times TEM image of the negative active material according to Example 1.

### DETAILED DESCRIPTION

Hereinafter, embodiments are described in more detail. However, these embodiments are exemplary, and do not limit the scope of the present disclosure, and the scope of the present disclosure is defined by the scope of the appended claims, and equivalents thereof.

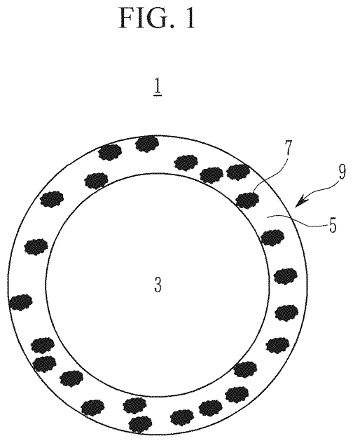

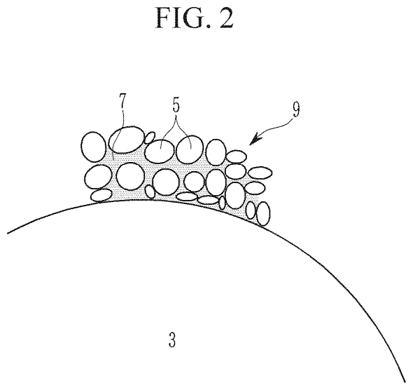

One embodiment provides a negative active material for a rechargeable lithium battery including a silicon primary particle core and a particle layer including agglomerated silicon oxide primary particles having a particle size in a range of about 10 nm or less. The silicon particle core may have a particle size of micrometers, and the particle layer may include pores and amorphous carbon may be filled in the pores. FIG. 1 schematically shows the structure of the negative active material. As shown in FIG. 1, a negative active material 1 according to an embodiment includes a silicon primary particle core 3 and a particle layer 9 formed on a surface of the silicon primary particle core 3. The particle layer 9 may be formed by agglomerating silicon oxide primary particles 5, and may include pores in which a carbon-based material 7 is filled in the pores. FIG. 1 shows that silicon oxide primary particles 5 are agglomerated to be present in a form of a layer. FIG. 2 further shows the structure of a portion of the particle layer 9. As can be seen in FIG. 2, the particle layer 9 is formed by agglomerating silicon oxide primary particles 5 and a carbon-based material 7 is filled in spaces (e.g., pores) which are present between the silicon oxide primary particles 5 as a result of agglomeration of the silicon oxide primary particles 5.

In an embodiment, as used herein, the term “core” indicates a region positioned inside of the active material, and when it is described in more detail, the core is a region surrounded by a coating layer (e.g., particle layer), so that the core is a region which is not substantially exposed outward. Thus, as described herein, a region positioned on the surface portion (outside) of the active material is considered to be a particle layer, and a region positioned inside of the particle layer is considered to be a core.

The silicon primary particle core may have a particle size of micrometers and may have a particle size in a range of about 1 μm to about 20 μm. The silicon particles including (e.g., consisting of) the core may be macro particles having a size of micrometers, and may be a single particle, for example, a primary particle that is not formed of agglomerated particles.

As used herein, the expression “size of the silicon primary particle core” may refer to an average particle size of the silicon primary particle core, and, as used herein, the term “size” may indicate a particle size “D50,” which is a particle diameter corresponding to 50% from the smallest particle size when the total number of particles is 100% in a distribution curve accumulated from the smallest particle size to the largest particle size.

Such a particle diameter D50, as described herein, may indicate an average particle diameter D50 where a cumulative volume is about 50 volume % in a particle distribution, when a definition is not otherwise provided.

The average particle diameter D50 may be measured by any suitable technique generally used in the art. In some embodiments, the average particle size D50 may be measured using a particle size analyzer, transmission electron microscope photography, and/or scanning electron microscope photography. Another method may be performed by measuring the average particle diameter D50 using a measuring device using dynamic light scattering, analyzing data to count a number of particles relative to each particle size, and then calculating to obtain an average particle diameter D50.

When a particle size of the silicon primary particle core is within the micrometer range, and, for example, within the above-described range, the high capacity of silicon may be utilized and the improvement effects in the cycle-life of a rechargeable lithium battery including the active material may be suitably obtained.

If the silicon primary particle core is very small and has a nanometer size, and, for example, has an average particle size D50 of less than 1 μm, the irreversible capacity is increased so that the effect of the high capacity of a rechargeable lithium battery including the active material cannot (or substantially cannot) be obtained. In some embodiments, if the silicon primary particle core is larger than a micrometer size, and, for example, has an average particle size D50 of more than 20 μm, the effect for improving the cycle-life of a rechargeable lithium battery including the active material may not be exhibited.

A particle layer may be formed on the surface of the core.

The particle layer may be continuously positioned on the surface of the core in a form of a layer, and according to one embodiment, the particle layer may be formed by substantially completely covering the surface of the core. For example, the particle layer may completely surround the core and no portion of the core may be exposed to the outside of the particle layer. When the particle layer is continuously positioned on the surface of the core in the form of the layer, to substantially completely cover the surface of the core, a side reaction with an electrolyte may be prevented or reduced to improve the cycle-life characteristics of a rechargeable lithium battery including the active material. If the particle layer is not formed to completely cover the surface of the core and is discontinuously positioned on the surface of the core to partially expose the surface of the core, a side-reaction with the electrolyte may occur to deteriorate or reduce the cycle-life characteristics of a rechargeable lithium battery including the active material.

The particle layer may be formed by agglomerating the silicon oxide primary particles which have a small size with a particle size of about 10 nm or less, and may include pores. The size of the silicon oxide primary particles may be about 10 nm or less, or in a range of about 1 nm to about 10 nm. When the size of the silicon oxide primary particles is about 10 nm or less, or, for example, in a range of about 1 nm to about 10 nm, a thick oxidation layer may be formed to improve the cycle-life and to provide a path for passing lithium ions, thereby resulting in high capacity of a rechargeable lithium battery including the active material. If the size of the silicon oxide primary particles is larger than 10 nm, the path for passing lithium ions may be blocked, and thus, the high capacity may not be achieved.

As used herein, the term “silicon oxide primary particle” refers to a single particle having a small size particle size which is about 10 nm or less.

The silicon oxide primary particles may be agglomerated to form a particle layer. When it is illustrated in more detail, at least one of the silicon oxide primary particles may be agglomerated to form a particle layer, and herein, the silicon oxide primary particles may be agglomerated to form a slightly loose particle layer (e.g., a layer having relatively low density) in order to form spaces (pores) between the silicon oxide primary particles, rather than forming a substantially dense particle layer.

As such, as the particle layer includes pores, the permeation of lithium ions through the particle layer may suitably occur. If the particle layer includes no pores, that is, the particle layer is a dense layer without pores, the permeation of lithium ions may rarely occur, so that the silicon primary particle core may not participate in the charging and discharging reactions.

Furthermore, the pores formed in the particle layer may have a pore diameter that is less than the thickness of the particle layer in order to not pierce the particle layer. For example, the pores are not so large as to form an opening that extends to the core, thereby exposing the core to the outside of the particle layer. If the pores are formed in a form of a penetration hole which is sufficient to pierce the particle layer (e.g., to expose the core to the outside of the particle layer), the path for permeating electrons and ions in the surface coating layer is not sufficient to increase resistance.

A carbon-based material may be filled in the pores of the particle layer. When the carbon-based material is filled in the pores of the particle layer, the carbon-based material may prevent or reduce the permeation of the electrolyte through the pores, so that the deterioration of the cycle-life characteristics of a rechargeable lithium battery including the active material due to the permeation of the electrolyte may be suppressed or reduced. As the carbon-based material does not suppress or reduce the permeation of lithium ions, the permeation effect of the lithium ions owing to the pores may be maintained and only the impregnation of the electrolyte may be suppressed or reduced. The carbon-based material may be amorphous carbon and/or crystalline carbon. In some embodiments, the carbon-based material may suitably be amorphous, as a suitable or desired structure of the active material may be more easily maintained, and the effects from filling the carbon-based material may be further increased.

In one embodiment, the carbon-based material may be positioned by filling the pores presented in the particle layer. If the carbon-based material is present in a separate layer from the particle layer, electrons and ions may not be passed through the pores within the particle layer.

The particle layer may have a thickness in a range of about 60 nm to about 500 nm, or about 61 nm to about 460 nm. As the particle layer includes pores, as described above, lithium ions may effectively permeate the particle layer so that the cycle-life characteristics of a rechargeable lithium battery including the active material may be effectively improved, even though the particle layer has a thickness in a range of about 60 nm to about 500 nm. Furthermore, the carbon-based material filled in the pores may suppress or reduce the permeation of the electrolyte through the particle layer to the core, so that the deterioration of the cycle-life characteristics due to the permeation of the electrolyte through the particle layer to the core may be suppressed or reduced, and the effect for improving the cycle-life characteristics of a rechargeable lithium battery including the active material due to the permeation of lithium ions may be well maintained.

If the particle layer is thinner than the above described range, it is difficult to suppress or reduce the volume change of the silicon primary particle core during charging and discharging. If the particle layer is thicker than the above described range, it is difficult to permeate lithium ions through the particle layer to the core during charging and discharging to reduce the initial efficiency and to increase irreversible capacity.

The thickness of the particle layer may be confirmed by measuring the particle layer thickness using a transmission electron microscope (TEM). For example, when the negative active material is measured using a TEM, with a reference as a region in which the shadow is changed, the inside is considered to be a silicon primary particle core and the outside is considered to be a particle layer, and a thickness from the region in which the shadow is changed to the outermost of the particle may be determined to be a thickness of the particle layer. In some embodiments, by performing transmission electron microscope-energy dispersive X-ray spectroscopy (TEM-EDS) analysis, a thickness from a point of inflection in which an amount of oxygen substantially changes to the outermost (e.g., the outermost portion of the particle) may be considered to be a thickness of the particle layer. For example, by performing TEM-EDS analysis, the distance from the outermost (e.g., the outermost portion of the particle) to the point of inflection in which an amount of oxygen is surprisingly changed from about 53 wt % to 0 wt % based on the total weight of the active material may be considered to be a thickness of the particle layer. Furthermore, when measured by the TEM, in a form of a particle in a region in which the shadow is changed, and, for example, in a region to be found as a brighter particle layer, a size of the slightly dark region may be considered to be a size of the silicon oxide (e.g., the core).

As described above, the negative active material including a silicon primary particle core having a particle size of micrometers, and a particle layer formed by agglomerating silicon oxide primary particles having a particle size of about 10 nm or less on the surface of the core and including pores in which the carbon-based material is filled, may exhibit high capacity due to the presence of the silicon primary particle core, and may provide easy permeation of lithium ions through the pores of the particle layer to the silicon primary particle core, and the carbon-based material filled in the pores may suppress or reduce the permeation of the electrolyte through the particle layer to the silicon primary particle core, so that the effect for improving the cycle-life characteristics of a rechargeable lithium battery including the active material may be obtained. If the size of the silicon primary particle core is out of the micrometer range, and, for example, is outside of a range of about 1 μm to about 20 μm, a particle layer includes no pores; if the particle layer includes pores but is not filled with a carbon-based material, or if the size of the silicon oxide primary particles is more than 10 nm, the desired excellent capacity and the cycle-life characteristics may not be obtained.

The silicon oxide may include, for example, SiO× (0<x≤2, or 0<x<2).

An amount of the carbon-based material may be about 1 wt % to about 5 wt % based on the total, 100 wt %, of the negative active material. When the amount of the carbon-based material is within the above range, the permeation of the electrolyte through the pores of the particle layer to the core may be prevented or reduced and the capacity of the active material may be highly maintained.

An amount of oxygen in the negative active material may be about 5 wt % to about 20 wt % based on the total, 100 wt %, of the negative active material. When the amount of oxygen is within the above range, the irreversible capacity may be low and the excellent cycle-life characteristics of a rechargeable lithium battery including the active material may be obtained. In one embodiment, the amount of oxygen may be confirmed by thermogravimetric analysis (TGA). The measurement of the amount of oxygen by thermogravimetric analysis may be determined by the reduced weight of the negative active material while the temperature is increased to about 1000° C. under an oxygen atmosphere.

The negative active material according to one embodiment may be prepared by either of the following two methods, but the present disclosure is not limited thereto.

A first method includes adding silicon primary particles to a solvent to prepare a liquid including the silicon primary particles and admixing beads with the liquid including the silicon primary particles. The silicon primary particles used may have a micrometer size, for example, may have a particle size in a range of about 1 μm to about 20 μm. The beads that are admixed may be used for easy distribution (e.g., homogenization), and may include zirconia beads. The solvent may include water.

While admixing the beads, silicon reacts with the solvent, for example, water, to oxidize the silicon, and to partially dissolve it, thereby forming a silicon oxide having a particle size in a range of about 10 nm or less, and agglomerating at least one of silicon particles on the surface of the silicon, so that it adheres to the surface thereof. The oxide silicon oxide primary particles are loosely agglomerated to adhere to the surface of the silicon primary particles, and thus, the silicon oxide primary particles may be adhered to the silicon primary particles to present (e.g., to provide) spaces (pores) between the silicon oxide primary particles.

The mixing process may be performed for a time period in a range of about 3 hours to about 8 hours. When the mixing process is performed in the above range, the silicon oxide may be prepared at a suitable or desired amount. If the mixing process is performed for a time period of out of the range described above, too little oxidation of silicon may occur (or too much oxidation of silicon may occur).

Herein, the added amount of the beads may be in a range about 10 wt % to about 50 wt % based on 100 wt % of the silicon particles. When the added amount of the beads is within the above range, it may be uniformly (e.g., substantially uniformly) distributed in the solvent to uniformly (e.g., substantially uniformly) prepare oxides.

Thereafter, the mixed solution is spray dried, and the dried product is mixed together with a carbon precursor to coat the dried product together with the carbon precursor, followed by heat treatment, thereby preparing a negative active material.

The spray drying may be performed at a temperature in a range of about 150° C. to about 200° C. The drying may volatize water and thus a product in which the silicon oxide is adhered to a surface of the silicon may be prepared. If the spray drying is performed at a lower temperature than the above range, water may not be volatilized and remains. If the spray drying is performed at a higher temperature than the above range, it reacts with oxygen in the air to increase the oxidation degree. As the drying process, the spray drying process is suitable or desirable, as it has a merit for removing water and maintaining oxidation. If the drying process is performed by natural drying in which the mixed solution is dried as it is under ambient conditions, or by heat drying, it may not be desirable because the silicon primary particles may be agglomerated.

Furthermore, as the heat treatment is performed after coating the carbon precursor, the carbon precursor may be converted to a carbon-based material. The carbon precursor may be an amorphous carbon precursor, and the amorphous carbon precursor may include petroleum coke, coal coke, petroleum pitch, coal pitch, green cokes, or a combination thereof. The amorphous carbon may include soft carbon and/or hard carbon.

The heat treatment may be performed at a temperature in a range of about 900° C. to about 950° C. In some embodiments, when the heat treatment is performed at the above temperature, the carbon precursor may be converted to amorphous carbon among the carbon-based material. If the heat treatment is performed at a higher temperature than 950° C., silicon may react with carbon to prepare an undesired silicon carbide. If the heat treatment is performed at a lower temperature than the above range, the irreversible capacity of the carbon-based material may be increased.

In coating the dried product together with the amorphous carbon precursor, the amount of the amorphous carbon may be suitably controlled until the amount of the amorphous carbon in the final product may be in a range of about 1 wt % to about 5 wt % based on the total, 100 wt %, of the negative active material. For example, the dried product and the amorphous carbon precursor may be mixed to a weight ratio of about 99:1 to 95:5.

A second method for preparing the negative active material includes mixing large silicon particles having a particle size of micrometers, for example, in a range of about 10 μm to about 20 μm, small silicon oxide particles having a particle size of nanometers, for example, about 10 nm or less, and an amorphous carbon precursor and sintering the resulting mixture. The sintering process may be performed at a temperature in a range of about 900° C. to about 950° C. The sintering process may be performed under a nitrogen atmosphere.

According to an embodiment, a rechargeable lithium battery including a negative electrode, a positive electrode, and an electrolyte is provided.

The negative electrode may include a current collector and a negative active material layer formed on the current collector, and the negative active material layer includes the negative active material according to an embodiment.

The negative active material layer may further include a carbon-based negative active material.

Examples of the carbon-based negative active material may include crystalline carbon, amorphous carbon, or a combination thereof. The crystalline carbon may be natural graphite and/or artificial graphite and have an unspecified shape, a sheet shape, a flake shape, a spherical shape, or a fiber shape, and the amorphous carbon may be soft carbon, hard carbon, mesophase pitch carbide, sintered cokes, and/or the like.

In the negative active material layer, the negative active material may be included in an amount in a range of 95 wt % to 99 wt % based on the total weight of the negative active material layer. If the negative active material layer includes both the negative active materials according to an embodiment, for example, a silicon-based negative active material (i.e. the negative active material for a rechargeable lithium battery according to the embodiment of the invention) and a carbon-based negative active material, the mixing ratio of the silicon-based negative active material to the carbon based negative active material may be in a range of about 5:95 to about 50:50 by weight ratio. When the mixing ratio of the silicon-based negative active material and the carbon-based negative active material is within the above range, expansion of the negative electrode may be inhibited or reduced during charging and discharging and higher capacity may be realized.

The amount of oxygen in the negative active material layer may be in a range of about 0.5 wt % to about 10 wt % based on the total, 100 wt %, of the negative active material layer. When the amount of oxygen in the negative active material is within the above range, the irreversible capacity may be effectively suppressed or reduced and the cycle-life characteristics of a rechargeable lithium battery including the active material may be well maintained.

The negative electrode active material layer may include a binder, and may further optionally include a conductive material (e.g., an electrically conductive material). In the negative active material layer, an amount of the binder may be in a range of about 1 wt % to about 5 wt % based on the total weight of the negative active material layer. When the negative active material layer further includes a conductive material (e.g., an electrically conductive material), the negative active material layer includes about 90 wt % to about 98 wt % of the negative active material, about 1 wt % to about 5 wt % of the binder, and about 1 wt % to about 5 wt % of the conductive material.

The binder adheres negative active material particles to each other well and also adheres negative active materials to the current collector. The binder may include a non-water-soluble binder, a water-soluble binder, or a combination thereof.

The non-water-soluble binder may include polyvinyl chloride, carboxylated polyvinylchloride, polyvinylfluoride, an ethylene oxide-included polymer, polyvinyl pyrrolidone, polyurethane, polytetrafluoroethylene, polyvinylidene fluoride, polyethylene, polypropylene, polyamideimide, polyimide, lithium polyacrylate, or a combination thereof.

The water-soluble binder may include a styrene-butadiene rubber, an acrylated styrene-butadiene rubber, an acrylonitrile-butadiene rubber, an acryl rubber, a butyl rubber, a fluorine rubber, an ethylene propylene copolymer, polyepichlorohydrin, polyphosphazene, polyacrylonitrile, polystyrene, an ethylene propylene diene copolymer, polyvinylpyridine, chlorosulfonated polyethylene, latex, a polyester resin, an acryl resin, a phenol resin, an epoxy resin, polyvinyl alcohol, or a combination thereof.

When the water-soluble binder is used as a negative electrode binder, a cellulose-based compound may be further used as a thickener to provide viscosity. The cellulose-based compound includes one or more selected from carboxymethyl cellulose, hydroxypropyl methyl cellulose, methyl cellulose, and alkali metal salts thereof. The alkali metals may include Na, K, and/or Li. The thickener may be included in an amount in a range of 0.1 parts by weight to 3 parts by weight based on 100 parts by weight of the negative active material.

The conductive material is included to provide electrode conductivity, and any suitable electrically conductive material may be used as a conductive material unless it causes a chemical change (e.g., an undesirable or unsuitable chemical change to the battery or any of its components). Examples of the conductive material include: a carbon-based material such as natural graphite, artificial graphite, carbon black, acetylene black, ketjen black, denka black, a carbon fiber, and the like; a metal-based material of a metal powder and/or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof, but is not limited thereto.

The negative electrode may be prepared by mixing a negative active material, a binder, and optionally a conductive material in a solvent to prepare an active material composition, and coating the composition on a current collector. The solvent may include water.

Such a negative electrode preparation should be readily recognizable to a person having ordinary skill in the art upon reviewing the present disclosure, and therefore, further description thereof is not necessary here.

The positive electrode may include a positive current collector and a positive active material layer formed on the positive current collector.

The positive active material may include compounds that reversibly intercalate and deintercalate lithium ions (lithiated intercalation compounds). In some embodiments, it may include one or more composite oxides of a metal selected from cobalt, manganese, nickel, and a combination thereof, and lithium. Additional examples may include compounds represented by any one of the following chemical formulae. LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}C_{4-c}D_{c} (0.90≤a≤1.8, 0≤b≤0.5, 0≤c≤0.05); LiₐN_{1-b-c}Co_{b}X_{c}D_{α} (0.90≤a≤1.8, 0≤b≤0.5, 0≤c≤0.5, 0≤α≤2); LiₐN_{1-b-c}Co_{b}X_{c}O_{2-α}T_{α} (0.90≤a≤1.8, 0≤b≤0.5, 0≤c≤0.5, 0≤α≤2); LiₐNi_{1-b-c}Co_{b}X_{c}O_{2-α}T₂ (0.90≤a≤1.8, 0≤b≤0.5, 0≤c≤0.5, 0≤α≤2); LiₐN_{1-b-c}Mn_{b}X_{c}D_{α} (0.90≤a≤1.8, 0≤b≤0.5, 0≤c≤0.5, 0≤α≤2); LiₐN_{1-b-c}Mn_{b}X_{c}O_{2-α}T_{α} (0.90≤a≤1.8, 0≤b≤0.5, 0≤c≤0.5, 0≤α≤2); LiₐN_{1-b-c}Mn_{b}X_{c}O_{2-α}T_{α} (0.90≤a≤1.8, 0≤b≤0.5, 0≤c≤0.5, 0≤α≤2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); and LiₐFePO₄ (0.90≤a≤1.8).

In the above chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from an oxide of the coating element, a hydroxide of the coating element, an oxyhydroxide of the coating element, an oxycarbonate of the coating element, and a hydroxyl carbonate of the coating element. The compound for the coating layer may be amorphous and/or crystalline. The coating element included in the coating layer may include Mg, Al, Co, K, Na, Ca, Si, Ti, V, Sn, Ge, Ga, B, As, Zr, or a mixture thereof. The coating layer may be formed utilizing a method having no (or substantially no) adverse influence on properties of a positive active material by using these elements in the compound. For example, the method may include any suitable coating method such as spray coating, dipping, and/or the like, which should be readily recognizable by those of ordinary skill in the art upon reviewing the present disclosure, and therefore, further description thereof is not necessary here.

In the positive electrode, an amount of the positive active material may be in a range of 90 wt % to 98 wt % based on the total weight of the positive active material layer.

In one embodiment, the positive active material layer may further include a binder and a conductive material. Herein, each amount of the binder and the conductive material may be in a range of about 1 wt % to about 5 wt %, respectively, based on a total amount of the positive active material layer.

The binder improves binding properties of positive active material particles with one another and with a current collector. Examples of the binder may include polyvinyl alcohol, carboxymethyl cellulose, hydroxypropyl cellulose, diacetyl cellulose, polyvinylchloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to provide electrode conductivity. Any suitable electrically conductive material may be used as a conductive material unless it causes a chemical change in a battery (e.g., an undesirable or unsuitable chemical change to the battery or any of its components). Examples of the conductive material include a carbon-based material such as natural graphite, artificial graphite, carbon black, acetylene black, ketjen black, a carbon fiber, and the like; a metal-based material of a metal powder and/or a metal fiber including copper, nickel, aluminum, silver, and the like; a conductive polymer such as a polyphenylene derivative; or a mixture thereof.

The current collector may be an aluminum foil, a nickel foil, or a combination thereof, but is not limited thereto.

The positive electrode may be prepared by mixing a positive active material, a binder, and optionally a conductive material in a solvent to prepare an active material composition, and coating the active material composition on a current collector. Such a positive electrode preparation should be readily recognizable to a person having ordinary skill in the art upon review of the present disclosure, and therefore, further description thereof is not necessary here. The solvent may include N-methyl pyrrolidone, but is not limited thereto.

The electrolyte may include a non-aqueous organic solvent and a lithium salt.

The non-aqueous organic solvent serves as a medium for transmitting ions taking part in the electrochemical reaction of a battery.

The non-aqueous organic solvent may include a carbonate-based solvent, ester-based solvent, ether-based solvent, ketone-based solvent, alcohol-based solvent, and/or an aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, t-butyl acetate, methylpropionate, ethylpropionate, propylpropionate, γ-butyrolactone, decanolide, valerolactone, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone and/or the like. The alcohol-based solvent may include ethanol, isopropyl alcohol, and/or the like, and the aprotic solvent may include nitriles such as R—CN (wherein R is a hydrocarbon group having a C2 to C20 linear, branched, or cyclic structure and may include a double bond, an aromatic ring, and/or an ether bond) and/or the like, dioxolanes such as 1,3-dioxolane and/or the like, and/or sulfolanes and/or the like.

The non-aqueous organic solvent may be used alone or in a mixture. When the organic solvent is used in a mixture, the mixture ratio may be controlled in accordance with a suitable or desirable battery performance.

The carbonate-based solvent may suitably or desirably include a mixture of a cyclic carbonate and a chain carbonate. In this case, the cyclic carbonate and the chain carbonate may be mixed and used in a volume ratio in a range of 1:1 to 1:9, such that the performance of the electrolyte may be improved.

When the non-aqueous organic solvent is used in a mixture, a mixed solvent of a cyclic carbonate and a chain carbonate; a mixed solvent of a cyclic carbonate and a propionate-based solvent; or a mixed solvent of a cyclic carbonate, a chain carbonate, and a propionate-based solvent may be used. The propionate-based solvent may include methyl propionate, ethyl propionate, propyl propionate, or a combination thereof.

Herein, when the cyclic carbonate and the chain carbonate or the cyclic carbonate and the propionate-based solvent are mixed, they may be mixed in a volume ratio in a range of about 1:1 to about 1:9, and thus performance of an electrolyte solution may be improved. In addition, when the cyclic carbonate, the chain carbonate, and the propionate-based solvent are mixed, they may be mixed in a volume ratio in a range of about 1:1:1 to about 3:3:4. The mixing ratios of the solvents may be suitably or appropriately adjusted according to suitable or desirable properties.

The non-aqueous organic solvent may further include an aromatic hydrocarbon-based organic solvent in addition to the carbonate-based solvent. Herein, the carbonate-based solvent and the aromatic hydrocarbon-based organic solvent may be mixed in a volume ratio in a range of about 1:1 to about 30:1.

The aromatic hydrocarbon-based organic solvent may be an aromatic hydrocarbon-based compound of Chemical Formula 1.

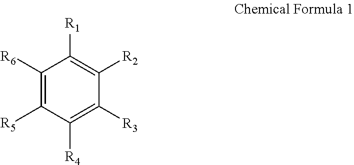

In Chemical Formula 1, R₁ to R₆ are the same or different and are selected from hydrogen, a halogen, a C1 to C10 alkyl group, a haloalkyl group, and a combination thereof.

Examples of the aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate or an ethylene carbonate-based compound represented by Chemical Formula 2 as an additive for improving the cycle-life of a battery.

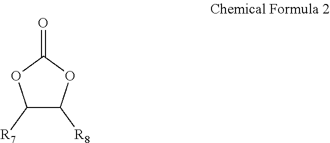

In Chemical Formula 2, R₇ and R₈ are the same or different and are selected from hydrogen, a halogen, a cyano group (CN), a nitro group (NO₂), and a fluorinated C1 to C5 alkyl group, provided that at least one of R₇ and R₈ is a halogen, a cyano group (CN), a nitro group (NO₂), or a fluorinated C1 to C5 alkyl group, and both of R₇ and R₈ are not hydrogen.

Examples of the ethylene carbonate-based compound may include difluoro ethylene carbonate, chloroethylene carbonate, dichloroethylene carbonate, bromoethylene carbonate, dibromoethylene carbonate, nitroethylene carbonate, cyanoethylene carbonate, and/or fluoroethylene carbonate. The amount of the additive for improving the cycle-life may be used within a suitable or appropriate range.

The electrolyte may further include vinyl ethylene carbonate, propane sultone, succinonitrile, or a combination thereof, and the amount thereof may be suitably controlled.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one supporting salt selected from LiPF₆, LiBF₄, LiSbF₆, LiAsFe, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂)(wherein x and y are natural numbers, for example, an integer of 0 to 20), lithium difluoro(bisoxolato) phosphate, LiCl, Lil, LiB(C₂O₄)₂ (lithium bis(oxalato) borate: LiBOB), and lithium difluoro(oxalate) borate (LiDFOB). The lithium salt may be used in a concentration in a range from 0.1 M to 2.0 M. When the lithium salt is included at the above concentration range, an electrolyte may have excellent performance and lithium ion mobility due to suitable or optimal electrolyte conductivity and viscosity.

A separator may be between the positive electrode and the negative electrode depending on a type (or kind) of the lithium secondary battery. Such a separator may include polyethylene, polypropylene, polyvinylidene fluoride, and/or multi-layers thereof such as a polyethylene/polypropylene double-layered separator, a polyethylene/polypropylene/polyethylene triple-layered separator, a polypropylene/polyethylene/polypropylene triple-layered separator, and/or the like.

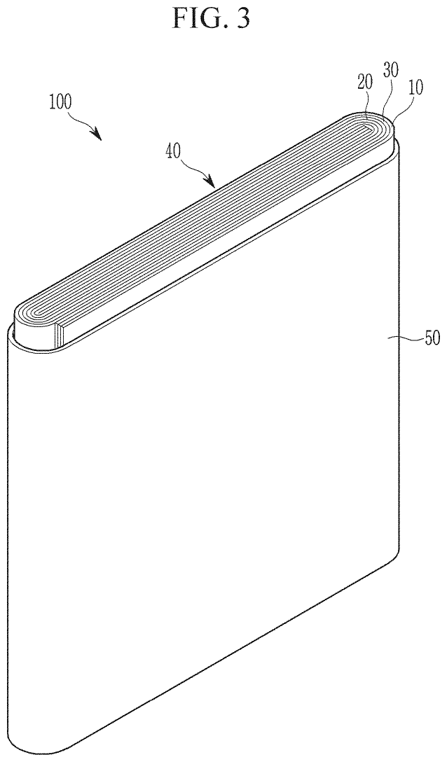

FIG. 3 is an exploded perspective view of a lithium secondary battery according to an embodiment. The lithium secondary battery according to an embodiment is illustrated as a prismatic battery, but is not limited thereto, and may include variously-shaped batteries such as a cylindrical or pouch-type (or kind of) battery.

Referring to FIG. 3, a lithium secondary battery 100 according to an embodiment includes an electrode assembly 40 manufactured by winding a separator 30 interposed between a positive electrode 10 and a negative electrode 20, and a case 50 housing the electrode assembly 40. In some embodiments, the positive electrode 10, the negative electrode 20, and the separator 30 may be impregnated with an electrolyte solution.

Hereinafter, examples of the present disclosure and comparative examples are described. These examples, however, are not in any sense to be interpreted as limiting the scope of the present disclosure.

### Example 1

50 wt % of silicon primary particles were added to water to prepare a liquid including the silicon primary particles, and zirconia beads were added to the liquid of the silicon primary particles and mixed for 3 hours. During the mixing, silicon oxide primary particles were formed and at least one of the silicon oxide primary particles was agglomerated and adhered to a surface of one of the silicon primary particles, thereby obtaining a product. Herein, the added amount of the zirconia bead was 30 wt % based on 100 wt % of the silicon particles, and in the product, the size of the silicon oxide primary particles was 10 nm.

Thereafter, the resultant mixed solution including the product was spray dried at 200° C. The dried product was mixed together with a petroleum pitch to a weight ratio of 97:3 to coat the dried product together with the petroleum pitch, and heat treated at 950° C. to prepare a negative active material. The resulting negative active material included a particle layer formed by agglomerating silicon oxide primary particles having a size of 10 nm on the surface of the silicon primary particles having a particle size of 5 μm, and the particle layer included pores in which amorphous carbon was filled. Herein, the thickness of the particle layer was 61 nm, and the amount of the amorphous carbon was 3 wt % of the total 100 wt %, of the negative active material. In the resulting negative active material, the amount of oxygen was 5 wt % based on the total, 100 wt %, of the negative active material.

The negative active material at 97.5 wt %, a styrene-butadiene rubber binder at 1.5 wt %, and carboxylmethyl cellulose as an agent for increasing viscosity at 1 wt % were mixed in a water solvent to prepare a negative active material slurry, where the wt % is based on the total weight of the negative active material slurry.

The produced negative active material slurry was coated on a Cu current collector, dried, and compressed to produce a negative electrode including a negative active material layer formed on the current collector. In the negative electrode, the amount of oxygen included in the negative active material layer was 1 wt % based on the total 100 wt % of the negative active material layer.

### Example 2

50 wt % of silicon primary particles were added to water to prepare a liquid including the silicon primary particles, and zirconia beads were added to the liquid including the silicon primary particle and mixed for 8 hours. During the mixing, the silicon oxide primary particles were formed and at least one of the silicon oxide primary particles was agglomerated and adhered to a surface of one of the silicon primary particles, thereby obtaining a product. Herein, the added amount of the zirconia beads was 30 wt % based on 100 wt % of the silicon particles, and in the product, the size of the silicon oxide primary particles was 10 nm.

Thereafter, the resultant mixed solution including the product was spray dried at 200° C. The dried product was mixed together with a petroleum pitch to a weight ratio of 97:3 to coat the dried product with the petroleum pitch and heat treated at 950° C. to prepare a negative active material. The resulting negative active material included a particle layer formed by agglomerating the silicon oxide primary particles having the particle size of 10 nm on the surface of the silicon primary particles having the particle size of 5 μm, and the particle layer included pores in which amorphous carbon was filled. Herein, the thickness of the particle layer was 463 nm, the amount of the amorphous carbon was 3 wt % of the total, 100 wt %, of the negative active material. In the resulting negative active material, the amount of oxygen was 20 wt % based on the total, 100 wt %, of the negative active material.

Using the negative active material, a negative electrode was prepared by substantially the same procedure as in Example 1.

### Reference Example 1

50 wt % of silicon primary particles were added to water to prepare a liquid including the silicon primary particles, and zirconia beads were added to the liquid of the silicon primary particle and mixed for 1 hour. During the mixing, the silicon oxide primary particles were formed and at least one of the silicon oxide primary particles was agglomerated and adhered to a surface of one of the silicon primary particles, thereby obtaining a product. Herein, the added amount of the zirconia beads was 30 wt % based on 100 wt % of the silicon particles, and in the product, the size of the silicon oxide primary particles was 10 nm.

Thereafter, the resultant mixed solution including the product was spray dried at 200° C. The dried product was mixed together with a petroleum pitch to a weight ratio of 97:3 to coat the dried product with the petroleum pitch and heat treated at 950° C. to prepare a negative active material. The resulting negative active material included a particle layer formed by agglomerating the silicon oxide primary particles having the particle size of 10 nm on a surface of one of the silicon primary particles having the particle size of 5 μm, and the particle layer included pores in which amorphous carbon was filled. Herein, the thickness of the particle layer was 39 nm, the amount of the amorphous carbon was 3 wt % of the total, 100 wt %, of the negative active material. In the resulting negative active material, the amount of oxygen was 2 wt % based on the total, 100 wt %, of the negative active material.

Using the negative active material, a negative electrode was prepared by substantially the same procedure as in Example 1. In the resulting negative active material, the amount of oxygen was 0.2 wt % based on the total, 100 wt %, of the negative active material layer.

### Comparative Example 1

50 wt % of silicon primary particles were added to water to prepare a liquid including the silicon primary particles, and zirconia beads were added to the liquid of the silicon primary particles and mixed for 8 hours. During the mixing, the silicon oxide primary particles were formed and at least one of the silicon oxide primary particles was agglomerated and adhered to a surface of one of the silicon primary particles, thereby obtaining a product. Herein, the added amount of the zirconia beads was 30 wt % based on 100 wt % of the silicon particles, and in the product, the size of the silicon oxide primary particles was 10 nm.

Thereafter, the resultant mixed solution including the product was spray dried at 200° C., and the dried product was heat treated 950° C. to prepare a negative active material. The resulting negative active material included a particle layer formed by agglomerating the silicon oxide primary particles having the particle size of 10 nm on the surface of the silicon primary particles having the particle size of 5 μm, and the particle layer included pores in which amorphous carbon was filled. Herein, the thickness of the particle layer was 463 nm. In the resulting negative active material, the amount of oxygen was 20 wt % based on the total, 100 wt %, of the negative active material layer.

Using the negative active material, a negative electrode was prepared by substantially the same procedure as in Example 1. In the resulting negative active material, the amount of oxygen was 4 wt % based on the total 100 wt % of the negative active material.

### Comparative Example 2

A negative active material was prepared by substantially the same procedure as in Example 1, except that silicon primary particles having a particle size of 100 nm were used.

The negative active material at 97.5 wt %, a styrene-butadiene rubber binder at 1.5 wt %, and carboxylmethyl cellulose as an agent for increasing viscosity at 1 wt % were mixed in a water solvent to prepare a negative active material slurry, where the wt % is based on the total weight of the negative active material slurry.

The produced negative active material slurry was coated on a Cu current collector, dried, and compressed to produce a negative electrode including a negative active material layer formed on the current collector. In the negative electrode, the amount of oxygen included in the negative active material layer was 1 wt % based on the total 100 wt % of the negative active material layer.

### TEM Image

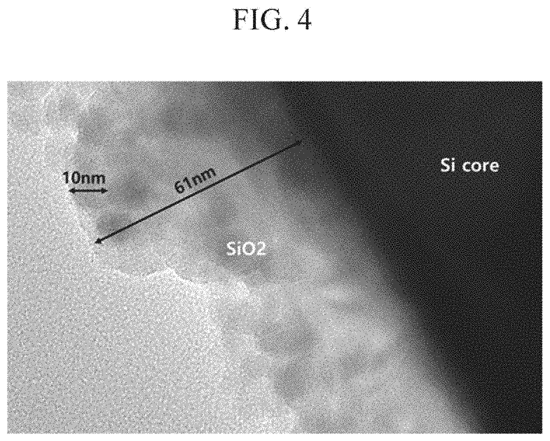

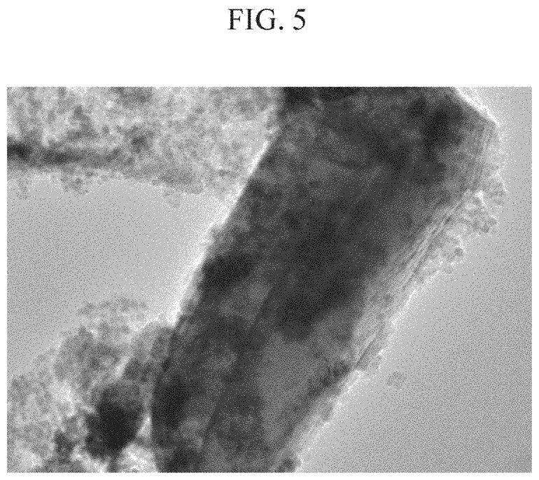

Regarding the surface of the negative active material of Example 1, a 150,000 times magnification TEM image and a 50,000 times magnification TEM image were taken, respectively. The results are shown in FIG. 4 (magnification: 150,000 times) and in FIG. 5 (magnification: 50,000 times), respectively.

As shown in FIG. 4, the region in which the shadow of the particle was changed was present, and among these, the darker black indicated the silicon primary particle core portion and the brighter region indicated the particle layer portion having a thickness of 61 nm. It can be seen that the size of the silicon oxide primary particle was 10 nm.

Furthermore, as shown in FIG. 5, all the surface of the silicon primary particle was covered with the silicon oxide particle layer.

### Fabrication of Cell

Respective ones of the negative electrodes according to Examples 1 and 2, Comparative Examples 1 and 2, and Reference Example 1, a positive electrode with a LiNi_{0.88}Co_{0.06}Al_{0.06}O₂ positive active material, and an electrolyte were used to fabricate rechargeable lithium cells according to a generally used method. As the electrolyte, 10 volume % of fluoroethylene carbonate added to 100 volume % of 1.0 M LiPF₆ dissolved in a mixed solvent of ethylene carbonate, diethyl carbonate and dimethyl carbonate (3/5/2 volume) was used.

### Measurement of Capacity

The cells were formation charged and discharged at 0.2 C once to measure the formation charge and discharge capacity. From these results, capacity per weight was obtained. The results of Examples 1 and 2, Comparative Example 1, and Reference Example 1 are shown in Table 1.

### Measurement of Capacity Retention

The cells were charged and discharged at 1 C for 500 times and the 1^{st} discharge capacity and 500^{th} discharge capacity were measured. From these results, the ratio of 500^{th} discharge capacity relative to 1^{st} discharge capacity was calculated.

The results are shown in Table 1.

TABLE 1

| | | Silicon | | | | | |
|---|---|---|---|---|---|---|---|
| | Silicon | oxide | | Amount | Particle | Capacity | 500th |
| | primary | primary | Amount of | of | layer | per | capacity |
| | particle | particle | carbon | oxygen | thickness | weight | retention |
| | core (μm) | (nm) | (wt %) | (wt %) | (nm) | (mAh/g) | (%) |
| Reference | 5 | 10 | 3 | 2 | 39 | 3621 | 16 |
| Example 1 | | | | | | | |
| Example 1 | 5 | 10 | 3 | 5 | 61 | 3473 | 86 |
| Example 2 | 5 | 10 | 3 | 20 | 463 | 3090 | 88 |
| Comparative | 5 | 10 | 0 | 20 | 463 | 3062 | 23 |
| Example 1 | | | | | | | |

As shown in Table 1, the cells of Examples 1 and 2 using the negative active material in which the size of the silicon primary particle core was micrometers, the size of the silicon oxide primary particle was 10 nm, and the thickness of the particle layer was 61 nm and 463 nm, respectively, exhibited excellent capacity and capacity retention. Whereas the cell of Reference Example 1 using the negative active material in which the thickness of the particle layer was very thin at 39 nm exhibited good capacity, but very low capacity retention at 16% which makes it impossible (or substantially impossible) to practically use. The cell of Comparative Example 1 using no amorphous carbon exhibited slightly low capacity and also a low capacity retention of 23%.

### Measurement of Initial Efficiency

The cells according to Example 1 and Comparative Example 2 were formation charged and discharged at 0.2 C once to measure the formation charge and discharge capacity. From these results, the initial efficiency was obtained. The result of Example 1 was 85%, whereas that of Comparative Example 2 was abruptly decreased, that is, 70%.

While the subject matter of this disclosure has been described in connection with what is presently considered to be practical exemplary embodiments, it is to be understood that the present disclosure is not limited to the disclosed embodiments.

On the contrary, it is intended to cover various modifications and equivalent arrangements included within the spirit and scope of the appended claims, and equivalents thereof.

What is claimed is:

1. A negative active material for a rechargeable lithium battery, comprising:
a silicon primary particle core having a particle size of micrometers;
a particle layer formed by agglomerating silicon oxide primary particles having a particle size of 10 nm or less on a surface of the core, the particle layer comprising pores; and
a carbon-based material filled in the pores of the particle layer

2. The negative active material for a rechargeable lithium battery of claim 1, wherein the silicon primary particle core has a particle size in a range of about 1 μm to about 20 μm.

3. The negative active material for a rechargeable lithium battery of claim 1, wherein the silicon oxide primary particle has a particle size in a range of about 1 nm to about 10 nm.

4. The negative active material for a rechargeable lithium battery of claim 1, wherein the particle layer has a thickness in a range of about 60 nm to about 500 nm.

5. The negative active material for a rechargeable lithium battery of claim 1, wherein the particle layer is continuously positioned on the surface of the core in a form of a layer.

6. The negative active material for a rechargeable lithium battery of claim 1, wherein an amount of the carbon-based material is in a range of about 1 wt % to about 5 wt % based on the total of 100 wt % of the negative active material.

7. The negative active material for a rechargeable lithium battery of claim 1, wherein the carbon-based material comprises amorphous carbon.

8. A rechargeable lithium battery comprising:
a negative electrode comprising the negative active material of claim 1;
a positive electrode; and
an electrolyte.

9. The rechargeable lithium battery of claim 8, wherein the negative electrode further comprises a carbon-based negative active material.
